(19) United States
(12) Patent Application Publication
(10) Pub. No.: US 2015/0118491 A1
(43) Pub. Date: Apr. 30, 2015

(54) HOLLOW GRAPHENE NANOPARTICLE AND METHOD FOR MANUFACTURING THE SAME

(71) Applicant: ENERAGE INC., Yilan County (TW)

(72) Inventors: Mark Y. WU, Yilan County (TW); Cheng-Yu HSIEH, Yilan County (TW); Cheng-Shu PENG, Yilan County (TW)

(73) Assignee: ENERAGE INC., Yilan County (TW)

(21) Appl. No.: 14/168,972

(22) Filed: Jan. 30, 2014

(30) Foreign Application Priority Data
Oct. 28, 2013 (TW) 102138919

(51) Int. Cl. C01B 31/04

(52) U.S. Cl. CPC C01B 31/0446; C01B 31/0492
USPC 428/401; 216/13

(57) ABSTRACT

Disclosed are a hollow graphene nanoparticle and a method for manufacturing the same. The hollow graphene nanoparticle is made of graphene sheets stacked together, and has a particle size of 10˜500 nm and a specific surface area greater than 500 m²/g. The method includes the steps of forming graphene, etching and heat treatment. First, a reducing agent is injected into an oven filled with protective gas, a carbon-containing gas compound or a second gas compound decomposing to generate carbon at higher temperature is added, a processing temperature is heated up to perform a redox reaction so as to form graphene nanoparticles containing side products, the graphene nanoparticles is then immersed in the acidic etching solution to remove the side products and obtain the hollow graphene nanoparticles.

### CROSS-REFERENCE TO RELATED APPLICATION

This application claims the priority of Taiwanese patent application No. 102138919, filed on Oct. 28, 2013, which is incorporated herewith by reference.

### BACKGROUND OF THE INVENTION

1. Field of the Invention

The present invention generally relates to a hollow graphene nanoparticle and a method for manufacturing the same, and more specifically to a nanometer hollow graphene particle and a method for manufacturing the same.

2. The Prior Arts

Graphene, that is, monolayer graphite, has a unique lattice structure composed of a monolayer of carbon atoms bound by sp2 chemical bond and closely packed so as to form a two dimensional honeycomb shape. Graphene thus has a thickness of only one carbon atom. It is believed that the graphitic bond is a hybrid chemical bond combining the covalent bond and the metallic bond. Therefore, graphene is a perfect combination of an electrical insulator and an electrical conductor. As the winners of the Nobel Prize in Physics for 2010, Andre Geim and Konstantin Novoselov successfully obtained graphene by peeling a piece of graphite with adhesive tape at the University of Manchester in the UK in 2004.

Graphene is the thinnest and hardest material in the world. Its thermal conductivity is greater than that of carbon nanotube and diamond, and its electron mobility at room temperature is higher than that of the carbon nanotube and silicon crystal. Additionally, the electric resistivity of graphene is even lower than that of copper or silver. So far, graphene is considered as the material with the lowest resistivity. The graphene and the carbon nanotube is one of the most suitable options in the flexible electronic materials because of the advantages of high flexibility and low reflectivity in the application of transparent electrodes. However, the graphene dispersion is more difficult to coat than carbon nanotube dispersion, because graphene congregates and stacks to each other easily. On the contrast, low concentration of graphene dispersion prevent the stacking issue, but it is relative hard to ensure graphene sheets contact sheet by sheet and the conductivity is thus decreased.

The traditional processes to fabricate the graphene generally have three categories: the graphite peeling process, the direct growth method and the method of carbon nanotube transformation. Specifically, the most suitable process for mass production is the redox reaction process, in which the graphite material is first oxidized to form graphite oxide, and then treatment of separation and reduction is performed to obtain the graphene.

US patent publication No. 20100237296, titled “Reduction of graphene oxide to graphene in high boiling point solvents”, disclosed a method of creating graphene, in which graphene oxide is first dispersed in water to form the graphene oxide dispersion, then a non-aqueous organic solvent is added into the dispersing agent to form a solution, and finally the temperature of the solution is heated up to about 200° C. to form graphene due to reduction. However, the degree of reduction is poor.

In U.S. Pat. No. 7,824,651, titled “Method of producing exfoliated graphite, flexible graphite, and nano-scaled graphene platelets”, particles of graphite are directly dispersed in a liquid medium containing a surfactant or dispersing agent to obtain a dispersion or slurry, and the dispersion or slurry is ground or process by ultrasonic waves at an energy level larger than 80W to peel off the monolayer graphite with a thickness smaller than 10 nm. This method is simple but it is still hard to obtain the desired size of graphene just by mechanical force, and additionally it takes a long period of processing time, thereby consuming much energy.

Another U.S. Pat. No. 7,658,901 with a title of “Thermally exfoliated graphite oxide” disclosed a method for manufacturing a thermally exfoliated graphite oxide, in which graphite oxide is placed in a heat source to form smaller reduced graphite oxide powder, and heated in another heat source for a period of time to obtain the final monolayer graphene product. The method is simple and fast, but it is hard to control the size of powder and the oxygen content in each batch of production. As a result, the quality of graphene product is seriously variable and uncontrollable.

### SUMMARY OF THE INVENTION

The primary objective of the present invention is to provide a hollow graphene nanoparticle, which constructed by stacked graphene sheets. The hollow graphene nanoparticle has a particle size of 10˜500 nm and a specific surface area greater than 500 m²/g. The graphene sheet has a thickness of 1˜50 nm and a planar lateral dimension of 10˜100 nm.

Another objective of the present invention is to provide a method of manufacturing hollow graphene nanoparticle, which includes the steps of forming graphene, etching and heat treatment. In the step of forming graphene, a reducing agent is injected into an oven filled with protective gas, a carbon-containing gas compound or a second gas compound decomposing to generate carbon when higher temperature is achieved, and a processing temperature is heated up to perform a redox reaction so as to form nanometer graphene particles containing side products.

The step of etching is to immerse the graphene particles in the acidic etching solution for a period of time to remove the side products and obtain the hollow graphene nanoparticle. The step of heat treatment is performed by placing the hollow graphene nanoparticle in the oven filled with the protective gas, and heating up to 700-1500° C. so as to lead to the lattice rearrangement of the hollow graphene nanoparticle, thereby reducing defect and further improving the degree of crystalline of the hollow graphene nanoparticle.

The present invention can stably obtain the hollow graphene nanoparticle with a particle size of 10˜500 nm, thus is obviously different from the prior arts, which physically peels off the graphite, or oxidizes the graphite. Therefore, it is possible to avoid using toxic or dangerous chemicals, and further obtain the advantages of a wide selection of reactants and easy fabrication.

### BRIEF DESCRIPTION OF THE DRAWINGS

The present invention can be understood in more detail by reading the subsequent detailed description in conjunction with the examples and references made to the accompanying drawings, wherein:

FIGS. 1A and 1B respectively show a perspective view and a cross-sectional view of hollow graphene nanoparticle according to one embodiment of the present invention;

FIG. 2 is a flowchart showing the method for manufacturing hollow graphene nanoparticle according to the present invention;

FIGS. 3(a) and 3(b) are high resolution TEM (Transmission electron microscopy) photos of the hollow graphene nanoparticle of Example 1;

FIG. 4(a) is the Raman spectrum of the hollow graphene nanoparticle; and

FIG. 4(b) is a high resolution TEM photo of the hollow graphene nanoparticle of Example 2.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

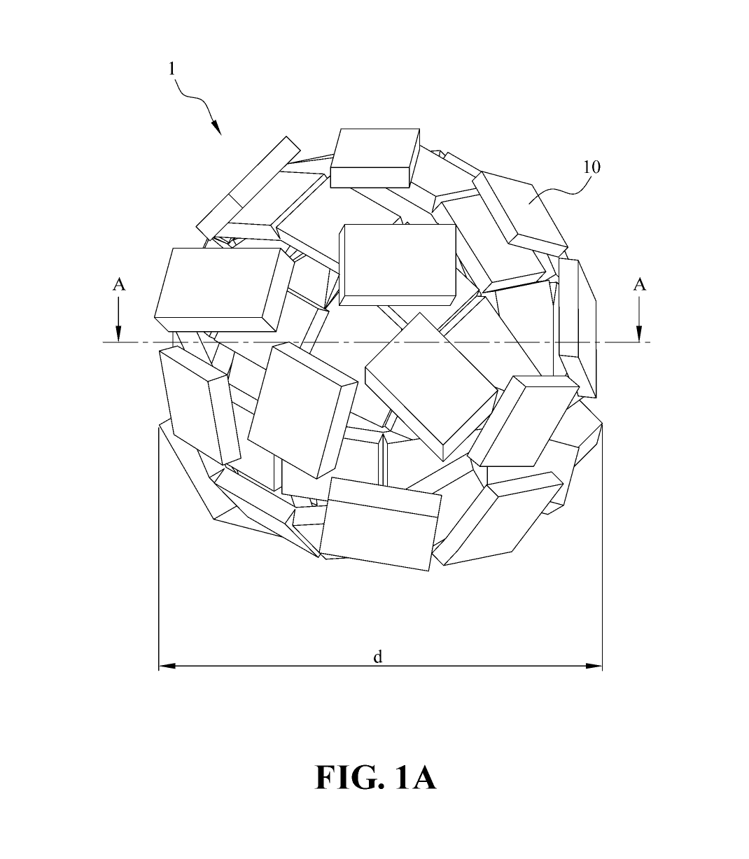

Please refer to FIGS. 1A and 1B, which show a perspective view and a cross-sectional view of the hollow graphene nanoparticle according to one embodiment of the present invention, respectively. It should be noted that FIGS. 1A and 1B are only illustrative examples to help understand the aspects of the present invention, and not scaled to the actual size. As shown in FIGS. 1A and 1B, the hollow graphene nanoparticle 1 of the present invention includes a plurality of graphene sheets 10, which are stacked together. Specifically, the particle size of each of the hollow graphene nanoparticle 1 is 10˜500 nm and its specific surface area is greater than 500 m²/g. In addition, the graphene sheet 10 has a thickness of 1˜50 nm and its planar lateral dimension is 10˜100 nm. The actual image of the hollow graphene nanoparticle is shown in reference 1, an electronic microscope photo.

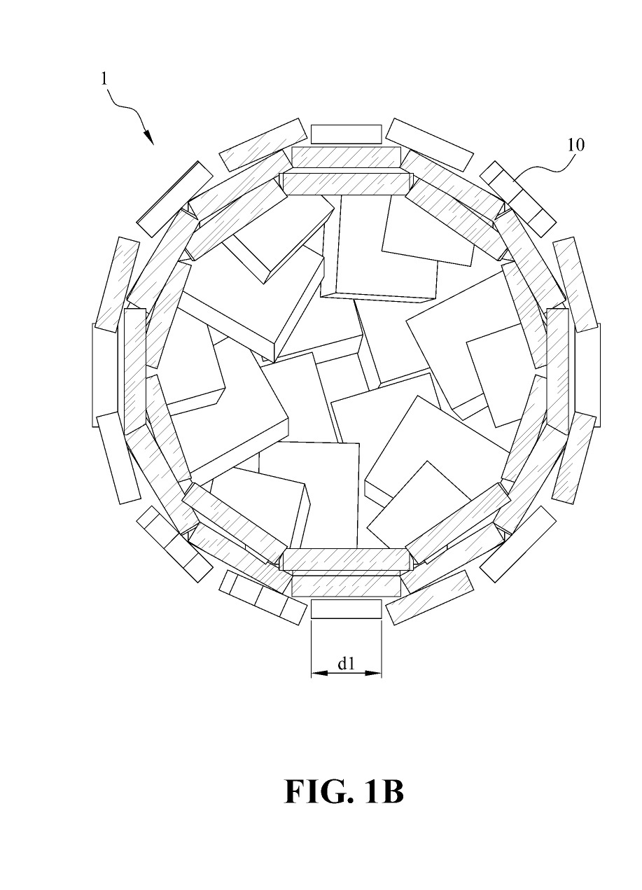

FIG. 2 is a flowchart showing the method for manufacturing hollow graphene nanoparticle according to the present invention. As shown in FIG. 2, the method 51 of the present invention generally includes the steps of forming graphene S10, etching S20 and heat treatment S30. In step of forming graphene S10, a reducing agent is injected into an oven filled with protective gas, at least one of the carbon-containing gas compound and the second gas compound decomposing to generate carbon when a higher temperature is achieved, and the temperature is further heated up to a processing temperature to perform a redox reaction so as to form graphene nanoparticles containing side products. The side product is the oxide of the reducing agent and the processing temperature is higher than the melting point of the reducing agent.

The above carbon-containing gas compound is preferably selected from a group consisting of at least one of carbon monoxide and carbon dioxide. The second gas compound is a hydrocarbon compound, which is selected from a group consisting of at least one of glucose, sucrose and starch. The reducing agent consists of at least one of an IA element, an IIA element, an element with electronegativity less than 1.8, and an element with oxidation half reaction potential between 0.5V and 3.1V. The reducing agent is in a gas, liquid or solid form. The temperature of the oven is 500° C. to 1700° C. The protective gas consists of at least one of 8A inert gases. Furthermore, an additional step of injecting ammonia gas can be implemented in the step S10 to obtain the nanometer graphene particles doped with nitrogen.

In the step S20, the nanometer graphene particles containing side products are immersed into an acidic etching solution to remove the side products so as to obtain the hollow graphene nanoparticle. More specifically, the acidic etching agent consists of at least one of nitric acid, sulfuric acid, hydrochloric acid, phosphoric acid and hydrofluoric acid. Finally, the step of heat treatment S30 is performed by placing the hollow graphene nanoparticle in the furnace filled with the protective gas, and heating up to 700-1500° C. to perform the heat treatment so as to reduce lattice defect and enhance degree of crystallinity of the hollow graphene nanoparticle.

To clearly explain the method for manufacturing the hollow graphene nanoparticle according to the present invention, four specific examples are described in detail hereinafter. However, it should be noted that the examples are only illustrative and not intended to limit the scope the present invention.

### EXAMPLE 1

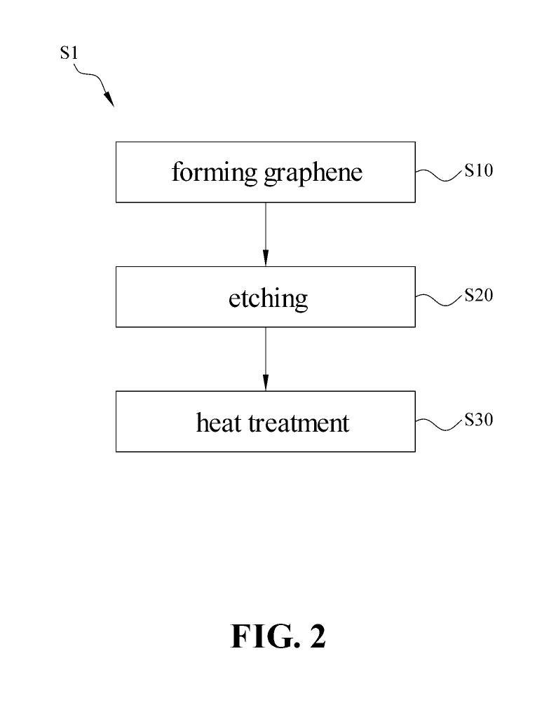

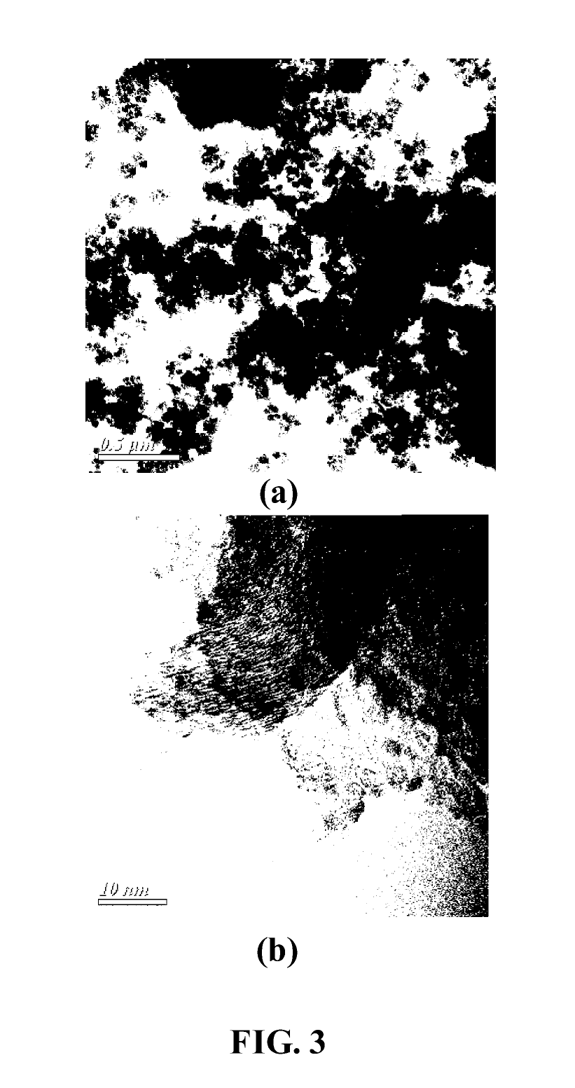

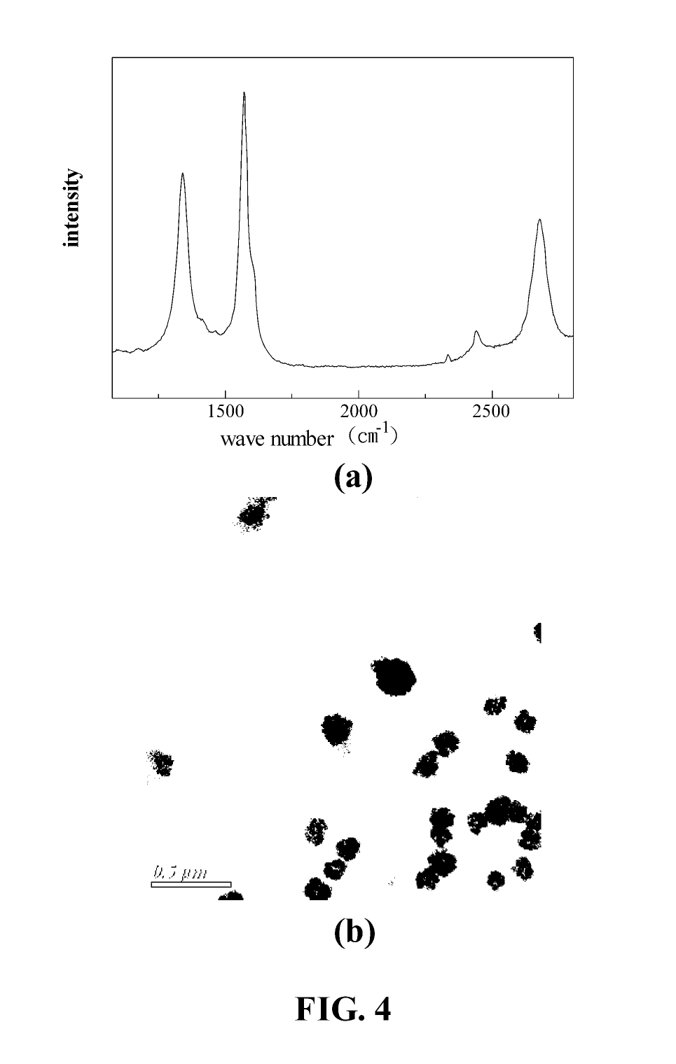

Carbon dioxide is used as the carbon-containing gas compound and magnesium powder is served as the reducing agent. First, the magnesium powder is placed in the oven, and then the mixture of argon and carbon dioxide is injected into the oven. The temperature of the oven is increased to 800° C. to conduct the desired reaction. After the reaction is completed, the graphene nanoparticle containing magnesium oxide is obtained. The graphene nanoparticle containing magnesium oxide is immersed in the solution of hydrochloric acid to etch the side product, i.e. magnesium oxide, so as to obtain the hollow graphene nanoparticle. Further, the heat treatment at 1000° C. is performed to increase the degree of crystallinity of the hollow graphene nanoparticle. As shown in FIG. 3(a), a high resolution TEM (Transmission electron microscopy) photo illustrates the detail of the hollow graphene nanoparticle. The particle size of the hollow graphene nanoparticle is about 40˜50 nm. Also shown in FIG. 3(b), the particles have the regular lattice arrangement in a specific direction. Further shown in FIG. 4(a), the Raman spectrum proves that the particle has the lattice structure of graphene. The specific surface area of the hollow graphene nanoparticle from the BET test is 710 m²/g.

### EXAMPLE 2

Glucose is selected for the second gas compound and similarly magnesium powder is used as the reducing agent. First, glucose and the magnesium powder are placed in the oven, and the oven is heated up to 800° C. such that glucose is decomposed to generate carbon-containing gas compound, which reacts with liquid magnesium. After the reaction is completed, the graphene nanoparticle containing magnesium oxide is obtained. The particles are immersed in the solution of hydrochloric acid to etch the side product, i.e. magnesium oxide, so as to obtain the hollow graphene nanoparticle. The heat treatment at 1000° C. is performed to increase the degree of crystallinity of the hollow graphene nanoparticle. As shown in FIG. 4(b), a high resolution TEM photo illustrates that the hollow graphene nanoparticle have the particle size of about 50˜60 nm. Additionally, the Brunauer-Emmett-Teller (BET) test confirms that the specific surface area of the hollow graphene nanoparticle is 680 m²/g.

### EXAMPLE 3

Magnesium powder as the reducing agent is placed in the first heating zone of the oven, and the temperature in increased up to 700° C. higher than the melting point of magnesium so as to evaporate the magnesium powder to form magnesium vapor. Argon is injected into the oven to carry the magnesium vapor into the reaction zone of the oven, where carbon dioxide as the carbon-containing gas compound is injected from the other side. The temperature of the reaction zone is set to 1000° C. such that magnesium and carbon dioxide perform the redox reaction to generate the nanometer graphene particles containing magnesium oxide. The particles is immersed in the solution of hydrochloric acid to etch the side product, i.e. magnesium oxide, so as to obtain the hollow graphene nanoparticle with the particle size of about 10˜30 nm.

### EXAMPLE 4

The reducing agent is a sodium slab, and is placed in the oven. Similarly, carbon dioxide is selected as the carbon-containing gas compound, and is mixed with argon, is injected together into the oven. The oven is heated up to 800° C. to cause the desired reaction. After the reaction is completed, the nanometer graphene particles containing sodium oxide is obtained. The particles are then immersed in the solution of hydrochloric acid to etch the side product, i.e. sodium oxide, so as to obtain the hollow graphene nanoparticle. The heat treatment at 1000° C. is performed to increase the degree of crystallinity of the hollow graphene nanoparticle. Specifically, the particle size is about 30˜50 nm.

From the above-mentioned, one aspect of the present invention is that the hollow graphene nanoparticle with the particle size of about 30˜50 nm is stably obtained. The technical features of the present invention are different from the traditional methods which physically peel off the graphite or oxidize the graphite. Therefore, toxic or dangerous chemicals are avoided, and additional advantages are obtained, such as a wide selection of reactants and easy fabrication in mass production.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hollow graphene nanoparticle, comprising;
a plurality of graphene sheets stacked together, wherein each of the graphene sheets has a thickness of 1˜50 nm and a planar lateral dimension of 10˜100 nm, and the hollow graphene nanoparticle has a particle size of 10˜500 nm and a specific surface area greater than 500 m²/g.

2. A method for manufacturing hollow graphene nanoparticle, comprising:
a step of forming graphene, injecting a reducing agent into an oven filled with protective gas, adding at least one of a carbon-containing gas compound or a second gas compound decomposing to generate carbon under higher temperature, and heating up to a processing temperature to perform a redox reaction so as to form nanometer graphene particles containing side products;
a step of etching, immersing the nanometer graphene particles containing side products into an acidic etching solution to remove the side products and form the hollow graphene nanoparticle; and
a step of heat treatment, placing the hollow graphene nanoparticle in an oven filled with protective gas, and heating up to 700-1500° C. to perform heat treatment so as to enhance degree of crystallinity of the hollow graphene nanoparticle,
wherein the hollow graphene nanoparticle is made of graphene sheets stacked together.

3. The method as claimed in claim 2, wherein the carbon-containing gas compound is selected from a group consisting of at least one of carbon monoxide and carbon dioxide, the second gas compound is a hydrocarbon compound selected from a group consisting of at least one of glucose, sucrose and starch, and the side products including an oxide of the reducing agent.

4. The method as claimed in claim 2, wherein the reducing agent consists of at least one of an IA element, an IIA element, an element with electronegativity less than 1.8 and an element with oxidation half reaction potential between 0.5V and 3.1V.

5. The method as claimed in claim 2, wherein the oven in the step of forming graphene is heated up to 500˜1700° C.

6. The method as claimed in claim 2, wherein the protective gas consists of at least one of 8A inert gases.

7. The method as claimed in claim 2, wherein the acidic etching agent consists of at least one of nitric acid, sulfuric acid, hydrochloric acid, phosphoric acid and hydrofluoric acid.

8. The method as claimed in claim 2, wherein the processing temperature is higher than a melting point of the reducing agent.

9. The method as claimed in claim 2, further comprising a step of injecting ammonia gas in the step of forming graphene to obtain the nanometer graphene particles doped with nitrogen.
